(19) United States
(12) Patent Application Publication
(10) Pub. No.: US 2005/0002279 A1
(43) Pub. Date: Jan. 6, 2005

(54) Time-of-day apparatus receiving standard time code broadcast

(75) Inventor: Takayuki Kondo, Hyogo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 10/843,665

(22) Filed: May 12, 2004

(30) Foreign Application Priority Data
May 15, 2003 (JP) 2003-137784

(51) Int. Cl. H04N 7/00

(52) U.S. Cl. 368/104

(57) ABSTRACT

A standard broadcast receiving time-of-day apparatus capable of using a crystal oscillator of low accuracy and saving the power consumption. This includes a receiver for receiving the standard broadcast, a time unit using a quartz oscillating circuit, and a time controller for calibrating an internal time-of-day signal which the time unit counts by using the standard time-of-day signal superimposed on the standard broadcast, and the time controller requires and stores a deviation between the internal time-of-day signal and the standard time-of-day signal and calibrates the internal time-of-day signal by using the stored deviation when failing to receive the standard broadcast. A clock pulse extracted from the carrier wave of the standard broadcast may be counted for a predetermined period and the frequency deviation of an internal clock may be calibrated by checking the count number of the internal clock counted for the above period. Or, the internal clock may be calibrated by using the carrier wave of the standard broadcast as a reference clock of the PLL circuit.

### BACKGROUND OF THE INVENTION

1. Field of the Invention

The present invention relates to a time-of-day apparatus for receiving a standard time code broadcast and performing time-of-day calibration.

2. Description of the Related Art

Japan Standard Time is consistently transmitted by means of LF (low frequency) broadcasts from two stations in Japan which are directly managed by the independent corporation, Communications Research Laboratory. Hereafter, the LF broadcast for transmitting the Japan Standard Time described above is referred to as “Standard Broadcast.” Currently, there are two standard broadcasts respectively of carrier frequencies 40 kHz and 60 kHz, and these LF waves of the different carrier frequencies are transmitted respectively from the above stations.

The carrier wave of the standard broadcast is subjected to the pulse amplitude modulation, according to the time-of-day data pulse string of the Japan Standard Time converted into the digital signal of a predetermined format. The time-of-day data pulse string is constituted of one frame of 60 bits/minute and the one frame includes the time-of-day data such as year, month, day and hour, minute, second. The bit rate of the time-of-day data pulse string is defined as 1 bit/second.

The time-of-day apparatus for receiving the standard broadcast, calibrating time-of-day, and displaying the calibrated time-of-day is in wide use as a so-called radio-wave clock (refer to Japanese Patent Kokai No. 2002-131456 (Patent Document 1)). The outline of the radio-wave clock will be described below.

At first, upon receipt of the standard broadcast, a radio receiver of the radio-wave clock amplifies the received signal to a predetermined level and then, extracts the signal components near the carrier frequency by using a band-pas filter of a predetermined bandwidth. Then, it detects the extracted signal components and demodulates them into the time-of-day data pulse string of the Japan Standard Time superimposed on the standard broadcast. A digital processor of the radio-wave clock reproduces the digital signals indicating the time-of-day data from the demodulated time-of-day data pulse string and supplies the same to a time unit of the radio-wave clock. Based on the reproduced digital signals, the time unit calibrates the internal time-of-day which its own quartz oscillating circuit is counting, and displays the time-of-day at each instant. Owing to the above structure, the radio-wave clock can display the extremely accurate time-of-day in synchronization with the Japan Standard Time.

The receiving condition of the standard broadcast in the radio-wave clock varies greatly depending on its setting place and environmental conditions. For example, if the radio-wave clock is placed in a house with steel-reinforced concrete walls or on a basement floor of a building, the receiving condition would significantly be deteriorated because of the attenuation of the arriving wave. Also, if there exist a number of sources of radio wave noises around the radio-wave clock, the receiving condition of the radio-wave clock would be deteriorated by the influence of such noises. As mentioned above, since the radio-wave clock contains the quartz oscillating circuit for time-of-day counting, even when the radio-wave clock falls into a state incapable of receiving the standard broadcast correctly, the display time-of-day of the radio-wave clock will not turn to be incorrect immediately.

When the reception fail state continues for a long time, however, there is a possibility of causing an error in the display time-of-day depending on the accuracy of a crystal oscillator used for a quartz oscillating circuit included in the radio-wave clock. Accordingly, in order to decrease the error of the display time-of-day, it is necessary to use a crystal oscillator of high accuracy and naturally this increases the manufacturing cost disadvantageously.

The radio-wave clock generally operates the radio receiver intermittently in order to save the power consumption. Accordingly, when the time intervals of the intermittent operation are expanded, the power consumption can be saved, but when the receiving condition is deteriorated, the reception fail state continues for a long time and an error in the displayed time-of-day is easy to happen. While, when the time intervals are shortened, an error in the display time-of-day can be decreased even in the case where the receiving condition is deteriorated, but the power consumption is increased disadvantageously.

The invention has been made in order to solve the above problems, and an object to be solved by the invention is to provide a standard broadcast receiving time-of-day apparatus that can reduce the power consumption even with a crystal oscillator of low accuracy.

### SUMMARY OF THE INVENTION

A standard broadcast receiving time-of-day apparatus according to the invention is to receive the standard broadcast, extract the time information and the frequency information included in the above wave, and correct the deviation of the measurement time inside the system and the deviation of the oscillation frequency of the quartz oscillating circuit.

### BRIEF DESCRIPTION OF THE DRAWINGS

FIG. 1 is a block diagram showing a first embodiment of the standard broadcast receiving time-of-day apparatus according to the invention.

FIG. 2 is a time chart showing the operation in the embodiment of FIG. 1.

FIG. 3 is a time chart showing the operation in the conventional radio-wave clock.

FIG. 4 is a view showing an example of variation in the time-of-day deviation according to a change of ambient temperature in a day.

FIG. 5 is a block diagram showing a fourth embodiment of the standard broadcast receiving time-of-day apparatus according to the invention.

FIG. 6 is a block diagram showing a fifth embodiment of the standard broadcast receiving time-of-day apparatus according to the invention.

FIG. 7 is a block diagram showing a sixth embodiment of the standard broadcast receiving time-of-day apparatus according to the invention.

### DETAILED DESCRIPTION OF THE INVENTION

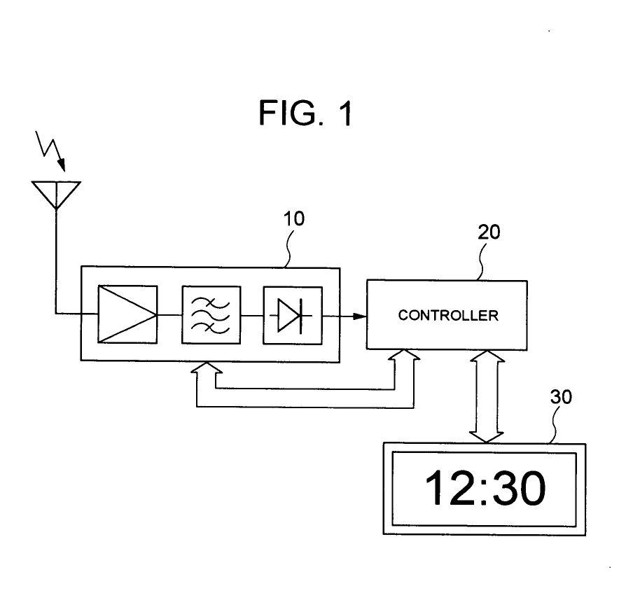

A first embodiment of the standard broadcast receiving time-of-day apparatus according to the invention will be described based on the block diagram of FIG. 1.

As shown in FIG. 1, the system according to this embodiment chiefly comprises a radio receiver unit 10, a controller 20, and a clock unit 30.

The radio receiver unit 10 is mainly formed by the circuits including a receiving antenna, a high frequency amplifier, a band-pass filter, and a detector, and it plays a role of receiving, detecting, and demodulating the standard broadcast. Although it is not shown in FIG. 1, it is needless to say that the radio receiver unit 10 includes various auxiliary circuits including an AGC circuit and an AFC circuit which are naturally to be equipped in a general low frequency receiver.

The controller 20 is constituted mainly of a microcomputer, memories such as ROM and RAM, and various circuits of the peripheral units (none of which are illustrated). In the memories, a main program and various kinds of subprograms (none of which are illustrated) for defining the operations of the respective units are stored. The microcomputer controls the whole operations of the system by running these programs in synchronization with a predetermined clock.

The clock unit 30 is constituted mainly of a quartz oscillating circuit for time-of-day count, a time-of-day display panel, and various kinds of circuits such as a display panel driving circuit (none of which are illustrated). On the time-of-day display panel, the time-of-day at each instant and the other calendar data are displayed. It is needless to say that the display time-of-day on the clock unit 30 is properly controlled by the controller 20.

The block diagram of the system shown in FIG. 1 is only an exemplary embodiment of the invention, but the classification of each component is not restricted to this structure. For example, the controller 20 and the clock unit 30 may be integrated into one circuit, and additionally, the radio receiver unit 10 and the above may be integrated into one circuit.

The internal time-of-day generating unit in Claims corresponds to the clock unit 30 and the time controller corresponds to the controller 20. Similarly, the time-of-day deviation storing device and the self-calibrating component in Claims correspond to the processing operation means run in the microcomputer within the controller 20.

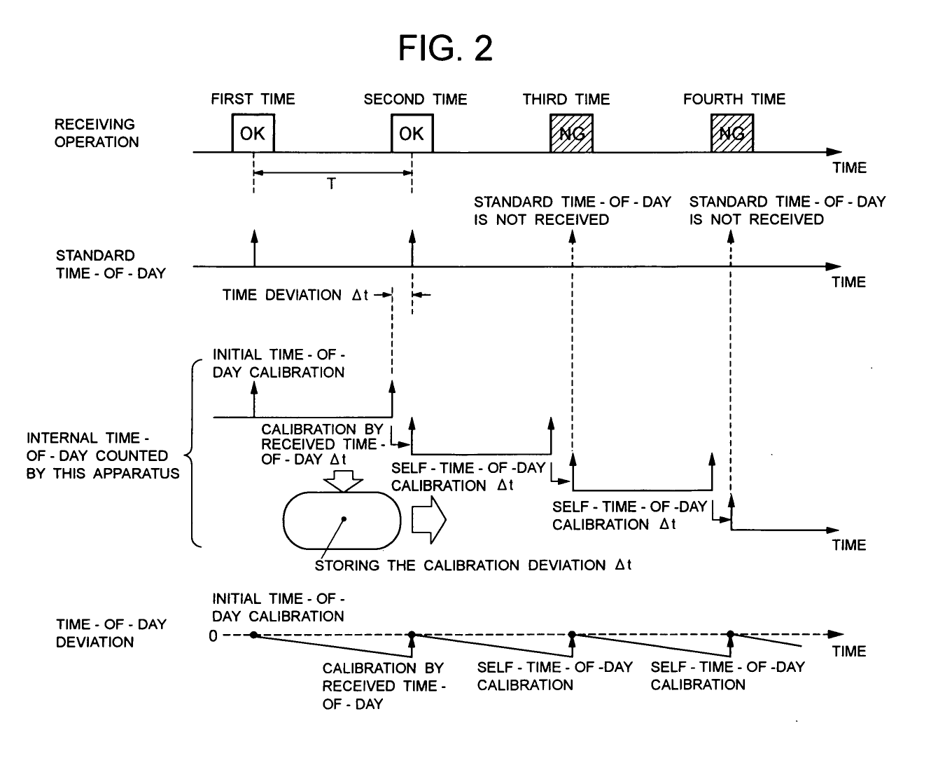

The operation of the first embodiment according to the invention will be described with reference to the time chart shown in FIG. 2. In the time chart shown in this figure, the radio receiver unit 10 is assumed to operate intermittently at the time intervals of T. In the following description, Japan Standard Time received from the standard broadcast will be referred to as the standard time-of-day signal and the time which the quartz oscillating circuit within the clock unit 30 counts will be referred to as the internal time-of-day signal.

At first, the controller 20 performs the initial time calibration to adjust the internal time-of-day signal to the Japan Standard Time, by using the standard time-of-day signal received through the first receiving operation of the standard broadcast after starting the operation of the system. The above initial time calibration may be performed by the first receiving operation of the standard broadcast just after power-on, or it may be performed by receiving the standard broadcast just after a user's input of a predetermined reset instruction. Alternatively, it may be performed by the combination of the above conditions.

After the initial time calibration, the quartz oscillating circuit of the clock unit 30 continuously counts the internal time-of-day signal. A crystal oscillator included in the above circuit generally has a frequency deviation at its manufacturing time. When this frequency deviation is positive, the quartz oscillating circuit by using the crystal oscillator arrives at the count number, which the quartz oscillating circuit having no deviation can count for a predetermined period, earlier than the above predetermined period of time. This is defined as a negative time-of-day deviation, and in the contrary case, namely when the crystal oscillator has a negative frequency deviation, this is defined as a positive time-of-day deviation.

In the system of FIG. 1, assuming that the crystal oscillator used for the quartz oscillating circuit has the positive frequency deviation, the negative time-of-day deviation occurs in the internal time-of-day signal, as mentioned above. This time-of-day deviation is gradually increased with the elapse of time, resulting in a time lag between the internal time-of-day signal and the standard time-of-day signal.

In the time chart of FIG. 2, when the time T has passed since the first receiving operation of the standard broadcast and the second receiving operation of the standard broadcast is correctly performed, the controller 20 performs the time calibration for calibrating the internal time-of-day signal by using the second received standard time-of-day signal.

In the calibration by the received time-of-day, the controller 20 requires the standard time-of-day signal received at second and the time-of-day deviation Δt between the internal time-of-day signal and the above signal. By advancing the internal time-of-day signal by Δt, the internal time-of-day signal is synchronized with the standard time-of-day signal. Owing to this, as shown in FIG. 2, the negative time-of-day deviation gradually increased with the elapse of time is once cleared into zero.

This embodiment is characterized in that the time-of-day deviation At is once stored in the memory within the controller 20 and that, what is called, the self-time-of-day calibration of calibrating the internal time-of-day signal by using the Δt is performed when the receiving operation of the standard broadcast in the third time and later is not performed normally.

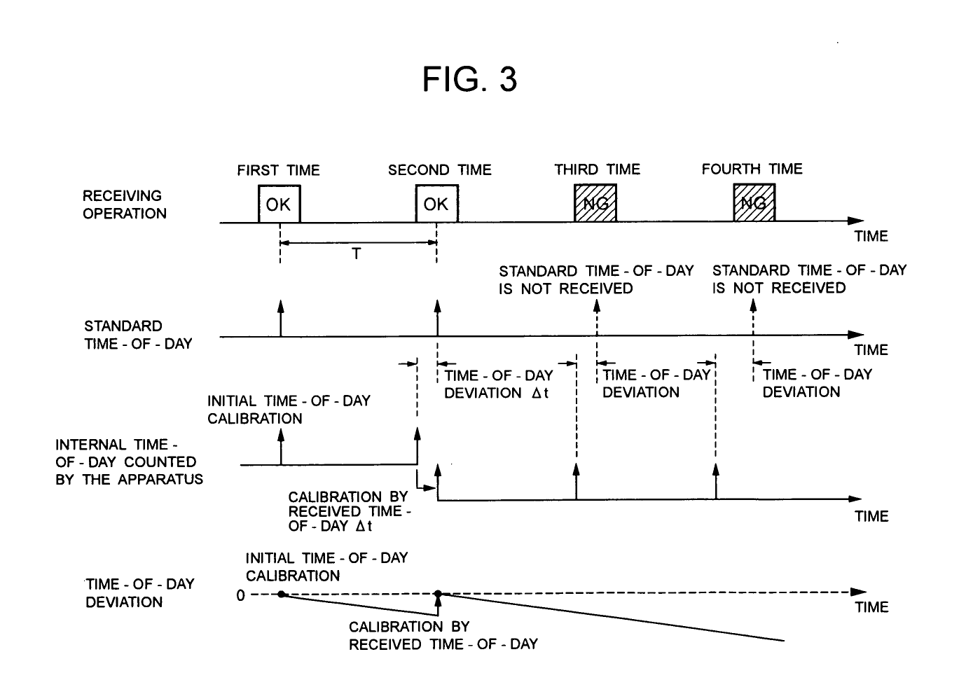

Namely, in the conventional radio-wave clock, when the third receiving operation and the subsequent operations are not performed normally due to the deterioration of the receiving state, it becomes naturally impossible to calibrate the internal time-of-day signal, as shown in the time chart of FIG. 3. Thus, as shown in the same diagram, the time-of-day deviation once cleared by the second receiving operation of the standard time-of-day signal is continuously increased in the negative direction thereafter, and a time lag between the internal time-of-day signal and the standard time-of-day signal is much more increased according to this increase of the time-of-day deviation.

On the contrary, this embodiment, even in the case of failing in the third receiving operation of the standard broadcast and failing to obtain the standard time-of-day signal, as shown in FIG. 2, the self-time-of-day calibration for calibrating the internal time-of-day signal by using the time-of-day deviation At stored in the memory within the controller 20 is performed at this receiving timing. Thus, the time-of-day deviation occurring between the standard time-of-day signal and the internal time-of-day signal is cleared again into zero. Further, even in the case of failing in the fourth and later receiving operation of the standard broadcast, since the self-time-of-day calibration is performed in the same procedure as the above, synchronization between the internal time-of-day signal and the standard time-of-day signal is always maintained.

In the case of succeeding in receiving the standard broadcast at the standard broadcast receiving timing of the fourth and later whereby the standard time-of-day signal from the standard broadcast is obtained, the internal time-of-day signal at the timing is calibrated by the received time-of-day signal. When the correct standard time-of-day signal is obtained at the next standard broadcast receiving timing, a new time-of-day deviation At is obtained according to the deviation from the above standard time-of-day signal and the new value is stored in the memory of the controller 20.

As mentioned above, according to the embodiment, time accuracy can be improved by performing the self-time-of-day calibration of the internal time-of-day signal. According to this, it is possible to use an inexpensive crystal oscillator having a large frequency deviation for the quartz oscillating circuit within the system.

Since the time intervals of the intermittent receiving operation of the standard broadcast can be expanded according to a decrease of the time-of-day deviation through the self-time-of-day calibration, it is possible to maintain the power consumption in the radio receiver unit 10.

In the above embodiment, although the time-of-day deviation between the standard time-of-day signal and the internal time-of-day signal is acquired by the continuous two receiving operations of the standard broadcast, the time-of-day deviation may be acquired from, for example, a plurality of receiving operations of the standard broadcast by using the static method. Alternatively, with a plurality of time-of-day deviations stored, the optimum time-of-day deviation may be acquired by using these values according to the static method.

Next, the second embodiment of the standard broadcast receiving time-of-day apparatus according to the invention will be described.

Since the structure of the hardware of the system in the embodiment is the same as that of the first embodiment, the block diagram shown in FIG. 1 is to be referred to in the following description. This embodiment is to be used together in the case of performing the self-time-of-day calibration of the internal time-of-day signal when failing to receive the standard broadcast in the first embodiment.

Generally, the ambient temperature at which the standard broadcast receiving time-of-day apparatus is set varies periodically in a day. While, the frequency deviation of the crystal oscillator has a temperature characteristic varying depending on its ambient temperature. Accordingly, the frequency deviation of the crystal oscillator included in the quartz oscillating circuit of the standard broadcast receiving time-of-day apparatus varies periodically in a day. As described in the first embodiment, a variation of the frequency deviation of the crystal oscillator appears as a time lag between the internal time-of-day signal the quartz oscillating circuit counts and the standard time-of-day signal received from the standard broadcast, namely the time-of-day deviation.

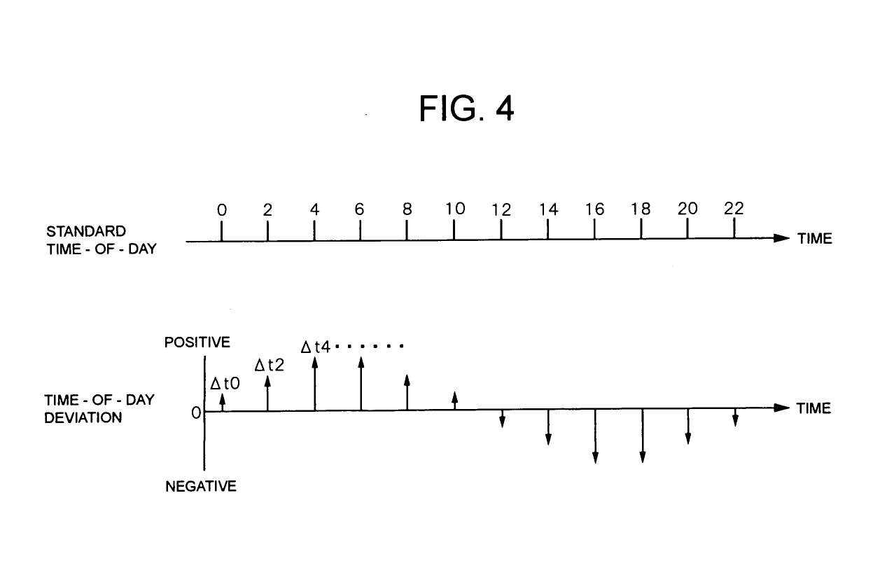

Here, assume that there occurs the time-of-day deviation as shown in FIG. 4 at each standard time in a day (24 hours), according to the ambient temperature change in a day in the system of FIG. 1. The values of the time-of-day deviation can be obtained through calibration by using the standard time-of-day signal received at each standard time. For example, the time-of-day deviation between the standard time-of-day signal received at the timing of two o'clock in the standard time and the internal time-of-day signal at that time becomes Δt2 and the time-of-day deviation between the standard time-of-day signal received at the timing of four o'clock in the standard time and the internal time-of-day signal at that time becomes Δt4.

In the embodiment, each time-of-day deviation is acquired at each standard time in a day (24 hours) and each value is stored in the memory within the controller 20. Although a time-of-day deviation is acquired in every two hours in FIG. 4, the embodiment is not restricted to this, but the time intervals of requiring and storing the time-of-day deviation may be set at any time.

The controller 20 stores the time-of-day deviation at a predetermined time in a day into the memory. When all the time-of-day deviations at each predetermined time are stored there, the controller 20 is to perform the self-time-of-day calibration of the internal time-of-day by using the time-of-day deviation stored in the memory. For example, when failing to receive the standard broadcast at the timing of 4 o'clock in the standard time and therefore failing to calibrate the internal time-of-day signal, the controller 20 performs the self-time-of-day calibration of the internal time-of-day signal by adding the time-of-day deviation Δt4 stored in the memory to the time-of-day deviation correction value Δt in the first embodiment.

Therefore, according to the embodiment, it is possible to further improve the time accuracy and to use a cheap crystal oscillator having a large frequency deviation for the quartz oscillating circuit. Further, it is possible to restrain the power consumption in the radio receiver unit 10 according to the expansion of the intervals of the intermittent receiving operations of the standard broadcast.

In the above description, although the structure of performing the self-time-of-day calibration of the internal time-of-day signal, with the time-of-day deviations over 24 hours once stored, has been described, the embodiment is not restricted to this. For example, the time-of-day deviations over 24 hours may be stored repeatedly and the statistical processing of the average of the movements may be performed on the stored data, thereby requiring the more suitable time-of-day deviation.

Next, the third embodiment of the standard broadcast receiving time-of-day apparatus according to the invention will be described.

Since the hardware structure of the system in this embodiment is the same as that of the first embodiment, the block diagram shown in FIG. 1 is to be used in the following description. Further, although the embodiment is to be used together in the case of performing the self-time-of-day calibration of the internal time-of-day signal when failing to receive the standard broadcast in the first embodiment, it may be performed in combination with the second embodiment.

Generally, as a change of the ambient temperature has a predetermined periodicity in a day, a change of the ambient temperature has a periodicity in a year. Since the data about the date is included in the standard time-of-day signal of the standard broadcast, the standard broadcast receiving time-of-day apparatus can recognize the date at a point of receiving the standard broadcast. Therefore, when the time-of-day deviations accompanying a change of the ambient temperature in a year are stored in the memory of the controller 20, it is not impossible to calibrate the time-of-day deviations accompanying a change of the ambient temperature in a year according to the same method as the second embodiment.

However, storing all the time-of-day deviations accompanying a change of the ambient temperature in a year into the memory is not economical from the viewpoint of the capacity of the memory, and in consideration of various environmental conditions under which the system is set, the above method is not practical.

A change of the ambient temperature in a day generally has a correlation to a change of the ambient temperature in a year. For example, under the air-conditioned and temperature-controlled environment, a temperature change in a day is small and at the same time, a temperature change in a year is also small. Therefore, it is quite possible to predict the time-of-day deviations accompanying a change of the ambient temperature in a year, based on the measured data of the time-of-day deviations according to a change of the ambient temperature in a day.

In this embodiment, first, the data about the year periodicity of the time-of-day deviations accompanying the standard change of the ambient temperature is stored in the memory of the controller 20 in a form of ROM table. In consideration of the periodicity of the time-of-day deviation data accompanying a change of the ambient temperature in a day, which has been collected in the above-mentioned second embodiment, the correction value of the time-of-day deviation is determined in every month or every season in a year.

For example, the controller 20 prepares the time-of-day deviation data according to a change of the standard ambient temperature in a day (24 hours) and requires the proportionality constant for calibration of the time-of-day deviation by comparison with the measured data of the time-of-day deviations in a day obtained in the above second embodiment. The measured data for several days may be prepared in order to decrease an error caused by scattering of the data and then, the proportionality constant may be acquired by using the statistical method.

The controller 20 calculates the standard predicted correction value of a year from the data about the year periodicity of the time-of-day deviation stored in the ROM table, multiplies the calculated correction value by the proportionality constant obtained in the above, and requires the time-of-day deviation correction value in every month or every season in a year.

The controller 20 is to perform the self-time-of-day calibration by adding the above-obtained time-of-day deviation correction value of a year to the internal time-of-day signal when performing the self-time-of-day calibration of the internal time-of-day signal.

According to the embodiment, the self-time-of-day calibration is enabled by predicting a change of the ambient temperatures in a year and it is possible to further improve the time accuracy. Therefore, it is possible to use a cheap crystal oscillator having a large frequency deviation for a quartz oscillating circuit and to restrain the power consumption in the radio receiver unit 10 according to the expansion of the time intervals of the intermitting receiving operations of the standard broadcast.

The fourth embodiment of the standard broadcast receiving time-of-day apparatus according to the invention will be described.

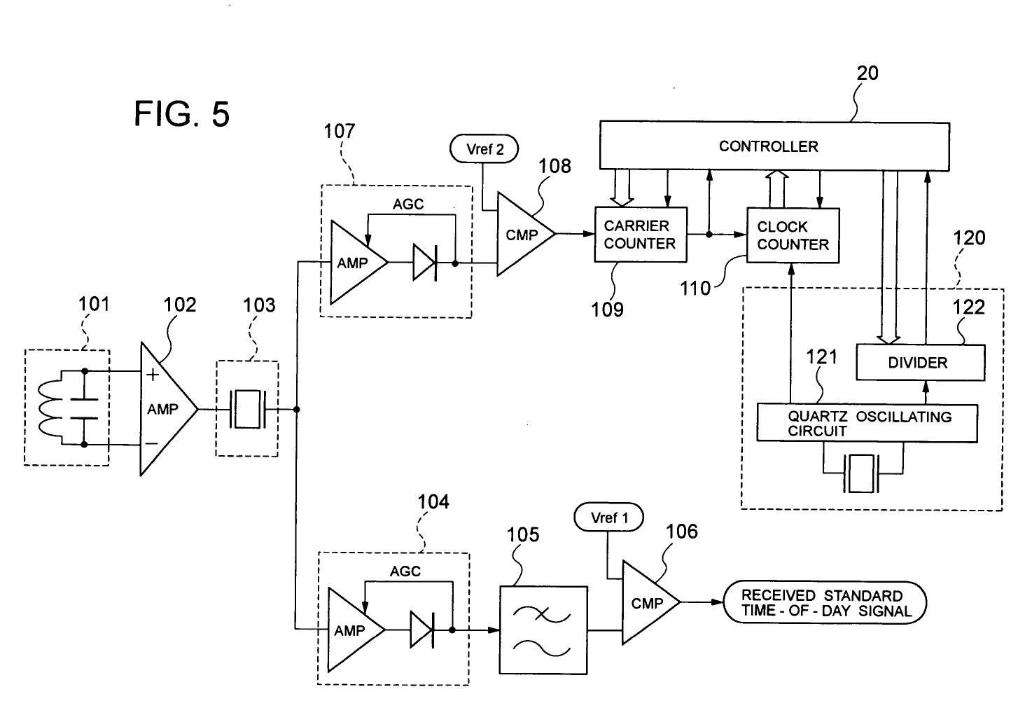

The structure of the system in the embodiment is shown in the block diagram of FIG. 5. The block diagram is to show only the portions concerned with the embodiment of the invention, and the description of the portions not directly concerned with the embodiment of the invention, for example, the description of the display of the time and its driving circuit, is omitted.

The structure of the embodiment will be described with reference to FIG. 5.

An antenna 101 in FIG. 5 is a low frequency receiving antenna such as a loop antenna and a ferrite antenna. The standard broadcast of low frequency transmitted from the standard broadcast station is modulated by the antenna 101 and received by the system as a feeble signal.

The high frequency amplifier 102 is a high frequency amplifier for amplifying a feeble received signal from the antenna 101 to a predetermined level, and the signal amplified by the above amplifier is supplied to the band-pass filter 103. The band-pass filter 103 is a band-pass filter of high selectivity (high Q) using, for example, a crystal oscillator and to attenuate the frequency component other than the main lobe bandwidth of the standard broadcast included in the received wave.

The received signal detector 104 is a circuit for amplifying the received signal extracted by the band-pass filter 103 to a predetermined level and detecting this. In order to realize the waveform of the envelope of the received signal faithfully, the received signal detector 104 is provided with an AGC function for properly controlling the amplification of the amplifier included in the same circuit according to its detected output.

The detected output signal from the received signal detector 104 is supplied to a low-pass filter 105 and the component of the carrier frequency of the standard broadcast included in the detected output signal is removed by the same filter, thereby reproducing the waveform of the envelope of the received signal.

The output of the low-pass filter 105 is further compared with a predetermined threshold voltage Vref1 according to a voltage comparator 106, and it is converted into a pulse string of digital signal having two values including high amplitude level and low amplitude level. This pulse string turns into the standard time-of-day signal indicating one frame of the standard time.

The standard time-of-day signal that is the output of the voltage comparator 106 is supplied to the controller 20 of the standard broadcast receiving time-of-day apparatus, hence to be used for the processing such as time calibration by reception and time display, but the description about such signal and processing is omitted because they have no concern directly with the structure of the embodiment.

While, the received signal extracted by the band-pass filter 103 is also supplied to a carrier signal detector 107. Though the above detector has the same structure as the above received signal detector 104, since it is to extract the component of the carrier frequency not envelope the waveform of the received signal, the set value of the AGC function in the above detector is different from that of the received signal detector 104.

The component of the carrier frequency included in the received signal is detected and extracted by the carrier signal detector 107 and supplied to the voltage comparator 108. The voltage comparator 108 compares the detected output with a predetermined threshold voltage Vref2 and converts this into a clock pulse of digital signal. The clock pulse is in synchronization with the received standard carrier wave and has the same cycle as the carrier frequency. In the following description, this clock pulse is to be referred as a carrier clock signal.

A carrier counter 109 is a so-called preset down-counter and to count down the initial set value of the counter set by the controller 20 described later by using the above carrier clock signal. It is needless to say that a control such as starting the count operation is performed by the controller 20.

A clock counter 110 is an up-counter of counting up a source clock signal supplied from the quartz oscillating circuit 121 included in a clock generator 120 described later. Though a count start of the clock counter 110 is instructed from the controller 20, a count stop is to be performed by an overflow signal occurring when the count initial set value becomes zero in the carrier counter 109. The count value of the clock counter 110 is to be notified to the controller 20 at a predetermined timing.

The controller 20 is mainly formed by a microcomputer, memories such as ROM and RAM, and various circuits of these peripheral units (none of which are illustrated). A main program and various kinds of subprograms (none of which are illustrated) for defining the operations of the respective units of the system are stored in the memories. The microcomputer controls the operations of the whole system by running these programs in synchronization with a predetermined clock.

The clock generator 120 is mainly formed by a quartz oscillating circuit 121 and a divider 122. The quartz oscillating circuit 121 is an oscillating circuit using a crystal oscillator, which provides the source clock signal that is the output therefrom, to the divider 122 and the above clock counter 110. The divider 122 is a dividing circuit for dividing the source clock signal according to a predetermined dividing ratio and the dividing ratio is to be set by the controller 20. The divided clock is supplied to the respective units within the system including the controller 20 as an internal clock signal. The clock generator 120 (quartz oscillating circuit 121) is always in an oscillating state.

The internal time-of-day signal is counted by using this internal clock signal in the system. This embodiment is to calibrate the accuracy of the internal clock signal by using the carrier frequency of the standard broadcast having the definite accuracy, thereby improving the time accuracy in this system.

The operation of the embodiment will be described by taking the concrete numerical examples. It is needless to say that the embodiment of the invention is not restricted to these numerical examples.

First, the controller 20 sets the value of “5,120,000” as the initial set value for counting down in the carrier counter 109 in the initial setting. This numeric value means the assumption that the carrier frequency is 40 kHz and that the measurement hour of the counter is 128 seconds. Namely, the number of the count pulses of the carrier clock signal (40 kHz) within the measurement hour (128 seconds)
40,000×128=5,120,000
becomes the initial set value for counting down of the carrier counter 109.

Assume that the numeric value of “32, 768” is set in the divider 122 within the clock generator 120 as the dividing ratio by the controller 20.

Upon completion of the above initial setting, the controller 20 notifies the carrier counter 109 and the clock counter 110 of a reset/start instruction. According to this, the carrier counter 109 starts the counting down of the initial set value and at the same time, the clock counter 110 starts counting up the source clock signal from the quartz oscillating circuit 121.

In the carrier counter 109, when the count value arrives at zero as a result of the continuous counting down of the initial set value, an over-flow signal notifying this is supplied to the clock counter 110 and the controller 20 respectively. The clock counter 110 stops the counting-up operation upon receipt of the signal. While, the controller 20 takes in the count value obtained by the clock counter 110 having counted up the source clock signal at a predetermined timing.

Assuming that the count value is “4,194,176”, the controller 20 calculates the count value per one second
4,194,176/128=32,767
by dividing this by the time 128 seconds required for the counting operation.

The calculated value becomes the dividing ratio for the source clock signal in order to obtain the internal clock signal of the same cycle as that of the carrier clock signal.

As mentioned above, since the dividing ratio initially set in the divider 122 is “32,768”, the frequency deviation in this case becomes
(32,768-32,767)/32,768=30.5 ppm.

The controller 20 sets the above calculated value “32,767” in the divider 122 within the clock generator 120 as a new dividing ratio.

In this embodiment, it is possible to always calibrate the frequency deviation of the internal clock signal by constantly repeating the above-mentioned operations. Thus, the same effect as the first to the third embodiments as mentioned above can be obtained.

It is needless to say that the calibration of the internal clock signal of the standard broadcast receiving time-of-day apparatus according to this embodiment may be performed by combination with the calibration of the time-of-day deviation shown in the first to the third embodiments as mentioned above.

This time, the fifth embodiment of the standard broadcast receiving time-of-day apparatus according to the invention will be described.

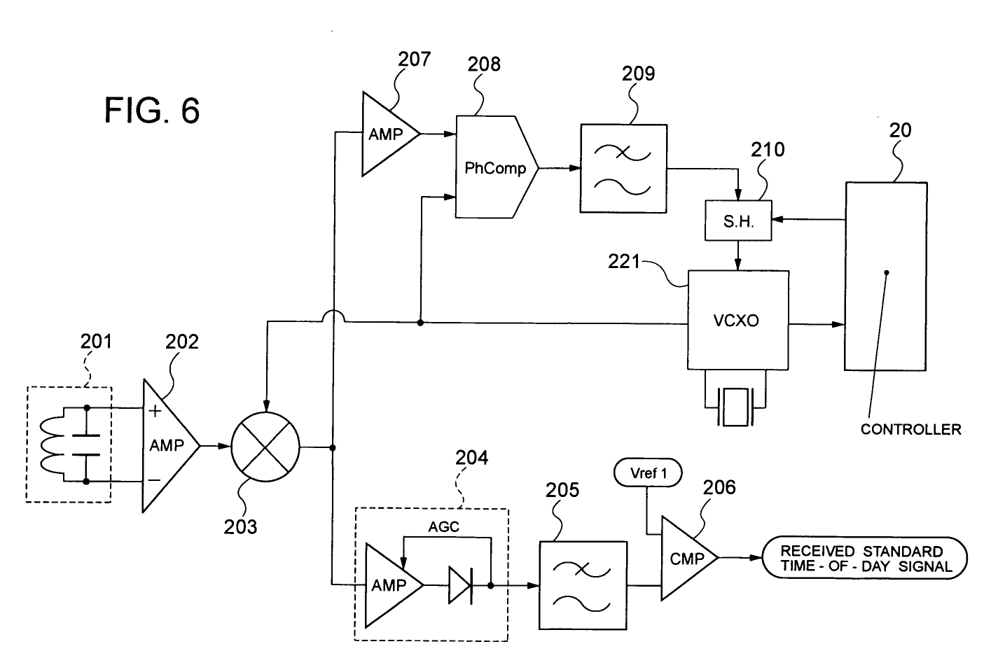

The structure of the apparatus according to the embodiment is shown in the block diagram of FIG. 6. This diagram is to show only the portions concerned with the embodiment of the invention and the description of the portions not directly concerned with the embodiment of the invention, for example, the description of the time display and the driving circuit, is omitted.

First, the structure of the embodiment will be described referring to the same diagram.

The antenna 201 in FIG. 6 is a low frequency receiving antenna such as a loop antenna and a ferrite antenna. The standard broadcast of low frequency transmitted from the standard broadcast station is modulated by the antenna 201 and received by the system as a feeble signal.

The high frequency amplifier 202 is a high frequency amplifier for amplifying a feeble received signal from the antenna 201 to a predetermined level, and the signal amplified by the amplifier is supplied to an analog multiplier 203. The analog multiplier 203 is a mixer using a modulator including an average modulator and a ring modulator, for multiplying the output signal from the high frequency amplifier 202 by the output signal from the voltage controlled-quartz oscillating circuit 221 which will be described later.

The received signal detector 204 is a circuit for amplifying the output signal from the analog multiplier 203 to a predetermined level and detecting this. In order to realize the waveform of the envelope of the output signal from the analog multiplier 203 faithfully, the received signal detector 204 is provided with an AGC function for properly controlling the amplification of the amplifier included in the same circuit according to its detected output.

The detected output signal from the received signal detector 204 is supplied to a low-pass filter 205 and the component of the carrier frequency of the standard broadcast included in the detected output signal is removed by the same filter, thereby reproducing the waveform of the envelope of the detected output signal.

The output of the low-pass filter 205 is further compared with a predetermined threshold voltage Vref1 according to a voltage comparator 206, and it is converted into a pulse string of digital signal having two values of high amplitude and low amplitude. This pulse string turns into the standard time-of-day signal indicating one frame of the standard time-of-day signal. The standard time-of-day signal that is the output of the voltage comparator 206 is supplied to the controller 20 hence to be used for the processing such as time calibration through reception and received time-of-day display, but the description about this processing is omitted because they do not directly relate to the structure of the embodiment.

While, the output signal from the analog multiplier 203 is also supplied to the carrier detection amplifier 207 and the output signal from the amplifier is applied to one input of a phase comparator 208. The phase comparator 208 is a circuit for supplying a signal according to the frequencies and the phase deviation of the two input signals by using, for example, an exclusive OR circuit. The output signal from the voltage controlled-quartz oscillating circuit 221 described later is supplied to the other input of the phase comparator 208.

The output signal of the phase comparator 208 is supplied to the low-pass filter (loop filter) 209, where the high frequency component is removed from the output signal, and then passing through a sample-and-hold circuit 210, it is supplied to the voltage controlled-quartz oscillating circuit 221. The gate control of the sample-and-hold circuit 210 is to be performed by the controller 20 described later.

The voltage controlled-quartz oscillating circuit 221 is a voltage controlled-oscillator in combination with a variable capacity element such as varactor diode and a quartz oscillating circuit, and its oscillation frequency is adjusted according to the direct voltage applied through the sample-and-hold circuit 210. Assume that the oscillation frequency of the voltage controlled-quartz oscillating circuit 221 is set at the vicinity of the carrier frequency (40 kHz or 60 kHz) of the standard broadcast.

It is needless to say that the above-mentioned phase comparator 208, loop filter 209, and voltage controlled-quartz oscillating circuit 221 forms a so called PLL (Phase Locked Loop) circuit.

The controller 20 is mainly formed by a microcomputer, memories such as ROM and RAM, and various circuits of these peripheral units (none of which are illustrated). The main program and various kinds of subprograms (none of which are illustrated) for describing the operations of the respective units are stored in the memories. The microcomputer controls the operations of the whole system by running these programs in synchronization with a predetermined clock.

The output signal from the voltage controlled-quartz oscillating circuit 221 corresponds to the internal clock signal of the system and this internal clock signal is used to count the internal time-of-day signal in this system. The embodiment is to calibrate the internal clock signal by synchronizing the internal clock frequency with the carrier frequency, by using the carrier frequency of the standard broadcast whose accuracy is defined, as a reference clock of the PLL circuit.

This time, the operation of the embodiment will be concretely described.

The received signal passing through the high frequency amplifier 202 is subjected to the multiply modulation processing by the output signal from the voltage controlled-quartz oscillating circuit 221, in the analog multiplier 203, hence to enhance the selectivity of the carrier frequency. The above modulation processing is nothing but the multiply processing of the above two signals. Therefore, the waveform of the envelope of the output signal from the analog multiplier 203 becomes the waveform of the pulse frequency of the standard time-of-day signal which has been superimposed on the carrier of the standard broadcast by amplitude modulation.

As mentioned in the fourth embodiment, the output signal from the analog multiplier 203 is applied to the received signal detector 204 to be subjected to the predetermined processing, and then reproduced as the standard time-of-day signal.

While, passing through the carrier detection amplifier 207, the output signal of the analog multiplier 203 enters the PLL circuit including the phase comparator 208, the loop filter 209, and the voltage-controlled quartz oscillating circuit 221 as a reference clock. The other input into the phase comparator 208 forming the PLL circuit is the internal clock signal that is the output signal from the voltage controlled-quartz oscillating circuit 221.

The phase comparator 208 creates a phase comparative signal between the output signal of the analog multiplier 203, namely the carrier clock signal, and the internal clock signal and supplies this to the loop filter 209. The loop filter 209 removes the high frequency component included in this phase comparative signal and extracts the direct current component from the same signal. Therefore, the direct current voltage in proportion to the degree of the deviation in the phase frequency between the carrier clock signal and the internal clock signal is generated in the output of the loop filter 209.

The direct current voltage enters the sample-and-hold circuit 210. As mentioned above, the gate of the sample-and-hold circuit 210 is controlled by a control signal from the controller 20. Before the synchronization is established between the internal clock signal and the carrier clock signal, the controller 20 performs a control of making the sample-and-hold circuit 210 through. According to this, the direct current output voltage from the loop filter 209 is applied to the control input of the voltage controlled-quartz oscillating circuit 221 and the voltage controlled-quartz oscillating circuit 221 oscillates the internal clock signal of the frequency according to the above voltage.

When the reception of the standard broadcast has got stable and the pull-in of the PLL circuit (lock of the PLL circuit) has been completed, the controller 20 controls the sample-and-hold circuit 210 to be locked, and according to this, the control voltage of the voltage controlled-quartz oscillating circuit 221 is fixed, hence to fix the oscillation frequency. Thereafter, even when the reception of the standard broadcast is interrupted, the voltage controlled-quartz oscillating circuit 221 continues the oscillation of the internal clock signal of the stable frequency.

As mentioned above, according to the embodiment, since the PLL circuit can be used to calibrate the accuracy of the internal clock signal by synchronizing the above signal with the carrier clock signal, the same effect as the first to the third embodiments can be obtained.

It is needless to say that the calibration of the internal clock signal of the standard broadcast receiving time-of-day apparatus according to the embodiment can be performed by combination with each calibration of the time-of-day deviation shown in the first to the third embodiments.

Since the selectivity of the carrier frequency of the standard broadcast is enhanced by using the analog multiplier, the band-pass filter of high selectivity (high Q) is not necessary in the former step of the detector, thereby decreasing the number of crystal oscillators required in the system.

The sixth embodiment of the standard broadcast receiving time-of-day apparatus according to the invention will be described.

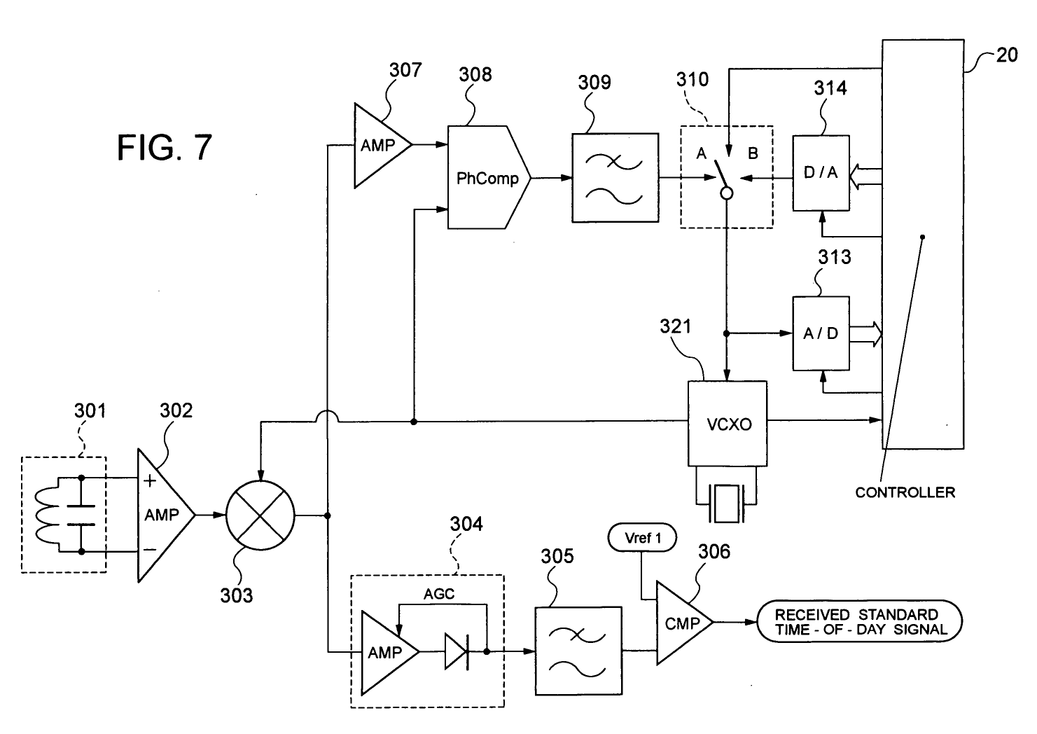

The structure of the system according to the embodiment is shown in the block diagram of FIG. 7. This block diagram is to show only the portions concerned with the embodiment of the invention, but the description of the portions not directly concerned with the embodiment of the invention, for example, the description of the time-of-day display and the driving circuit is omitted.

The structure of the embodiment will be described with reference to FIG. 7. This embodiment is based on the fifth embodiment, and to calibrate the internal clock frequency by using the carrier frequency of the standard broadcast as a reference clock of the PLL circuit. Therefore, only the portions added to the structure of the fifth embodiment are described hereafter.

In FIG. 7, a connection switch 310 is a signal switching circuit by using an analog signal switching element such as analog switch and a mercury relay, and the switching instruction is performed by a control signal form the controller 20. The sample-and-hold circuit 210 in the fifth embodiment is not used in this embodiment.

An analog/digital converter 313 is a circuit for converting a control voltage applied to a voltage controlled-quartz oscillating circuit 321 into a digital signal and the digital signal output from the above converter is read by the controller 20 at a predetermined timing. A digital/analog converter 314 is a circuit for converting the digital signal supplied from the controller 20 into an analog signal at a predetermined timing.

The concrete operation of this embodiment will be described. The following description will be made about only the portions different from the above-mentioned fifth embodiment.

At first, at the initial time when the system starts receiving the standard radio wave, the connection switch 310 switches the switching connection to the side of A as shown in FIG. 7, according to the control signal from the controller 20. Thus, the output of the loop filter 309 is connected to the control voltage input of the voltage-controlled oscillating circuit 321 and the same operation of the PLL circuit as the fifth embodiment is performed.

During the operation of the PLL circuit, the analog/digital converter 313 operates, sequentially converts the value of the control voltage applied to the voltage-controlled oscillating circuit 321 into a digital signal, and notifies the controller 20 of this value. The controller 20 can always monitor the change of the control voltage during the operation of the PLL circuit.

The controller 20 stores the state of the operation of the voltage-controlled oscillating circuit 321 according to the change of the control voltage, and judges the information about the stable operation such as jitter in the PLL circuit. Judging that the operation of the PLL circuit has got stable, a control of the voltage-controlled oscillating circuit 321 is directly switched from the PLL control to the direct control by the controller 20.

Here, the direct control by the controller 20 means the control method for controlling the oscillating frequency by the controller 20 which directly supplies a proper control voltage to the voltage-controlled oscillating circuit 321.

Namely, the controller 20 supplies a predetermined digital signal to the digital/analog converter 314 to generate a proper control voltage. Next, a switching control signal is supplied to the connection switch 310 and the switching connection is switched to the side of B shown in FIG. 7. According to this, a control voltage input of the voltage-controlled oscillating circuit 321 is connected to the output of the digital/analog converter 314 and the oscillating frequency is controlled by the control voltage supplied from the same converter.

The controller 20 operates the analog/digital converter 313 again after performing the switching operation and reads the control voltage of the voltage-controlled oscillating circuit 321 to judge whether the value is correct or not.

According to the embodiment, since the oscillating frequency of the voltage-controlled oscillating circuit 321 can be controlled directly from the controller 20, it is possible to adjust the oscillating frequency in consideration of the correction of the time-of-day deviation according to a change of the ambient temperature, for example, mentioned in the second and the third embodiments. In this case, since the internal clock frequency itself, not the time-of-day deviation, can be corrected, it is possible to supply the stable clock signal to the outside of the system.

According to the embodiment, the controller 20 can monitor the control voltage of the voltage-controlled oscillating circuit 321 at any time. Therefore, the controller 20 can smoothly find a state of causing a release of the phase lock of the PLL circuit due to the deterioration of the receiving state of the standard broadcast and a lock difficult state, and therefore, a control by the PLL circuit can be properly switched to a control by the controller 20, hence to obtain the stable internal clock signal.

As mentioned above, according to the embodiment, since the internal clock signal can be synchronized with the carrier clock signal by using the output from the PLL circuit and the controller 20, hence to calibrate the accuracy, it is possible to obtain the same effect as the above-mentioned first to third embodiments.

It is needless to say that calibration of the internal clock of the standard broadcast receiving time-of-day apparatus can be performed in combination with the calibration of the time-of-day deviation shown in the first to the third embodiments.

Further, since the selectivity of the carrier frequency of the standard broadcast can be enhanced by using the analog multiplex, a band-pass filter of high selectivity (high Q) is. not necessary in the prior step of the detector and therefore, it is possible to decrease the number of crystal oscillators required in the system.

This application is based on Japanese Patent Application No. 2003-137784 which is herein incorporated by reference.

1. A standard broadcast receiving time-of-day apparatus including a radio receiver for receiving a standard broadcast, an internal time-of-day generating unit for generating an internal time-of-day signal by using a quartz oscillating circuit, and a time controller for calibrating the internal time-of-day signal based on a standard time-of-day signal superimposed on the standard broadcast, wherein
the time controller comprises a time-of-day deviation storing device for detecting and storing a time-of-day deviation between the internal time-of-day signal and the standard time-of-day signal and
a self-calibrating component for calibrating the internal time-of-day signal by using the time-of-day deviation stored in the time-of-day deviation storing device when failing to receive the standard broadcast.

2. The standard broadcast receiving time-of-day apparatus according to claim 1, wherein
the time controller further comprises a second time-of-day deviation storing device for storing a time-of-day deviation caused by a change of ambient temperature at every standard time for every day, and
when calibrating the internal time-of-day signal, the self-calibrating component reads out the time-of-day deviation caused by the change of the ambient temperature at the calibration time, so to calibrate the internal time-of-day signal based on the above time-of-day deviation.

3. The standard broadcast receiving time-of-day apparatus according to claim 2, wherein
the time controller further comprises a third time-of-day deviation storing device for storing tendency data of the time-of-day deviation caused by the change of the ambient temperature for every year, and
when calibrating the internal time-of-day signal, the self-calibrating component reads out the time-of-day deviation caused by the change of the ambient temperature at the calibration time, so to calibrate the internal time-of-day signal based on the above time-of-day deviation.

4. The standard broadcast receiving time-of-day apparatus according to claim 3, wherein
the time controller corrects the data stored in the third time-of-day deviation storing device according to the tendency of the time-of-day deviation data stored in the second time-of-day deviation storing device.

5. A standard broadcast receiving time-of-day apparatus for calibrating time by receiving a standard broadcast, comprising:
a carrier wave clock generator for extracting a component of carrier wave from the standard broadcast and converting the component into a clock signal;
a first counter for counting down a predetermined count value of initial setting by using the clock signal;
an internal clock generator for dividing a clock signal from a quartz oscillating circuit according to the predetermined dividing ratio, so to generate an internal clock signal;
a second counter for starting count of the clock signal from the quartz oscillating circuit according to a count starting instruction and stopping the count upon completion of counting down by the first counter; and
a controller for setting the count value of the initial setting in the first counter, supplying the count starting instruction to the second counter, and setting the count value at a time of stopping the count of the second counter as the predetermined dividing ratio in the internal clock generator.

6. The standard broadcast receiving time-of-day apparatus for calibrating time by receiving a standard broadcast, comprising:
a multiplier for multiplying a received signal of the standard broadcast by the internal clock signal;
a control voltage generator for generating a control voltage based on a phase deviation between an output signal from the multiplier and the internal clock signal; and
a clock signal generator, including a quartz oscillating circuit capable of adjusting an oscillating frequency according to the control voltage, for generating the internal clock signal.

7. The standard broadcast receiving time-of-day apparatus according to claim 6, further comprising:
an analog/digital converter for converting the control voltage into a digital signal;
a digital/analog converter for converting a predetermined digital signal into the control voltage signal;
a connection switch for connecting the clock signal generator to the control voltage generator or the digital/analog converter in a switchable way, according to a signal of connection switching instruction; and
a controller for reading a digital signal from the analog/digital converter, writing a predetermined digital signal into the digital/analog converter, and supplying the signal of connection switching instruction to the connection switch, at a predetermined timing.
